(19) United States
(12) Patent Application Publication
(10) Pub. No.: US 2010/0218081 A1
(43) Pub. Date: Aug. 26, 2010

(54) METHOD FOR ORDERING INFORMATION

(76) Inventors: Michael D. Norman, Olathe, KS (US); Justin Ohmie, Merriam, KS (US)

Correspondence Address: ERICKSON, KERNELL, DERUSSEAU & KLEYPAS, LLC, 800 W. 47TH STREET, SUITE 401, KANSAS CITY, MO, 64112, US

(21) Appl. No.: 11/626,064

(22) Filed: Feb. 23, 2009

(51) Int. Cl. G06F 17/20; G06Q 90/00

(52) U.S. Cl. 715/222; 705/500; 715/221

(57) ABSTRACT

A relative ordering method is disclosed wherein generic items are ordered by using relative ordering information rather than explicit ordering information. The method allows items to be ordered relative to one another based on users' preferences.

The present invention relates to a method for ordering items based on relative ordering information, and more particularly, the present invention provides a method for ordering and placement of fields on a form based on relative ordering information for each field.

### BACKGROUND

Software programs have been created in the past to use lists of items to indicate order. These software programs are capable of using these lists of items directly, sorting them into an alphabetical or numerical ordering, or possibly randomizing the order.

In such systems, the user of the system is required to place items in a specific order in a list, not allowing for flexibility or possible reordering when necessary, even when the user may not care about the order of some items in the list. The list itself does not lend any contextual or intentional information about whether or not a specific order is required.

It is desirable to capture the intent of an ordered set of items rather than a simple list of items. In that way multiple orderings are possible, if necessary, without losing the original user intent.

### SUMMARY

The present invention provides a method to order items on a form without losing user intent by providing a mechanism for capturing ordering intent through relative order designations for individual fields. The items may be easily reordered by changing the relative order designation for one or more items without having to manually change the layout of the form. When laying out items on a computer screen, items that are smaller may fit in smaller spaces, leaving larger items room to expand. Allowing some flexibility in the order based on intention allows for this more efficient use of the available space. Items may fit better in computer memory if ordered differently. This would allow for more efficient memory usage by programs if the ordering is not explicit. When placing items on a printed page, similarly to a computer screen, items that fit in one place may not fit as well in another. The ability to shift these items around because of flexibility in order may allow all items to fit on one page rather than spill over onto another.

### BRIEF DESCRIPTION OF THE DRAWINGS

FIG. 1 is a table and display showing a prior art form built from fields designated in a specific order.

FIG. 2 is a table and display showing a form that is built from fields with only relative ordering information according to the method of the present invention.

FIG. 3 is a high level flow diagram of the ordering algorithm of the present invention.

FIG. 4 is a flow diagram of an algorithm for breaking an unordered list of items into a list of unbreakable chains of items of the present invention.

FIG. 5 is a flow diagram of an algorithm for ordering items in a particular unbreakable chain of items of the present invention.

FIG. 6 is a form created by the algorithm of the present invention.

FIG. 7 is a continuation of the form of FIG. 6.

### DETAILED DESCRIPTION

While the relative ordering system of the present invention may be adapted for use by any number of applications used in visual layout of items, it is particularly adapted for use with ProbuSoft Virtual Layout Artist. The specific implementation described here is part of the ProbuSoft .NET Utilities runtime, used in ProbuSoft Virtual Layout Artist. ProbuSoft Virtual Layout Artist is based on the concept of a hierarchical set of groups, fields, and text items. Users of the software can create groups to contain other groups, fields and text item. Users are then able to set the relative ordering information on items within each group. After this initial setup, the software will lay the items out on the page according to the method described hereinbelow.

Relative ordering information is used to gather the original intent from the user, rather than gathering just the end order. This ordering method allows the application to process the information, moving items to efficiently use the available space according to the user's requirements, if any.

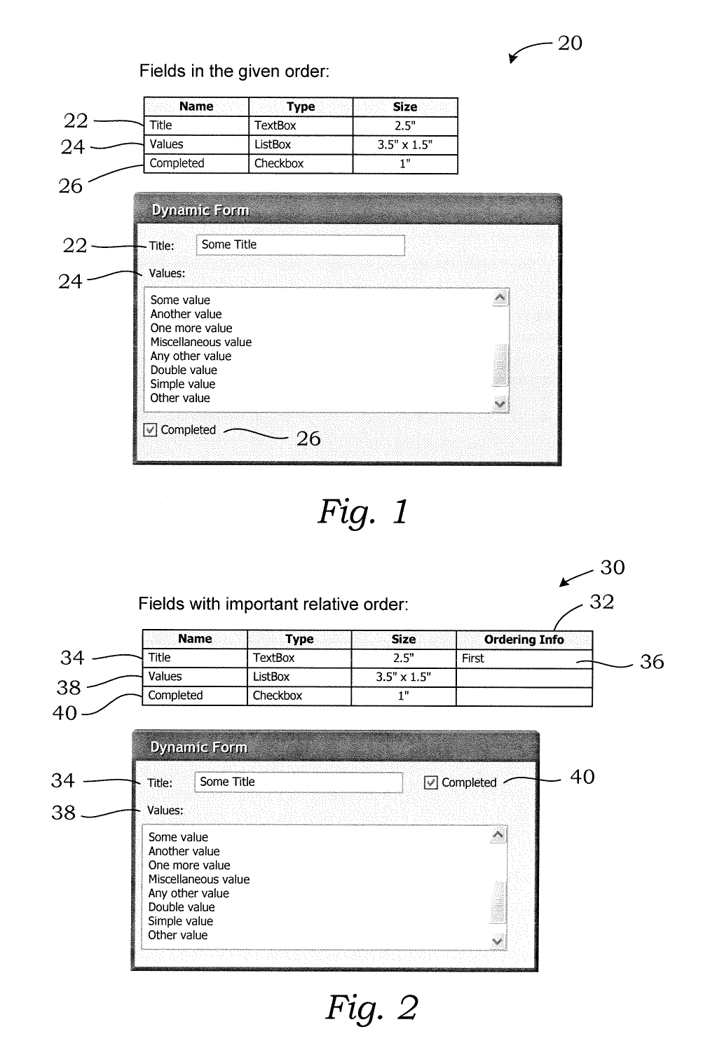

Referring initially to FIG. 1, a number of fields are defined in a table 20, each with certain characteristics. Title 22 is a text box with size of 2.5″, Values 24 is a list box with size of 3.5″×1.5″, and Completed 24 is a checkbox with size of 1″. Because these fields are specified with absolute ordering (first Title 22, second Values 24, and third Completed 26), the image of the Dynamic Form 28 shows the three elements in the layout specified in table 20.

Referring to FIG. 2 a table 30 includes relative ordering information 32, and any implicit order of the elements is ignored. Therefore, the only ordering information referred to is in the ordering info column 32, because that is what the user deemed important enough to specify. The Title entry 34 includes ordering information of First 36. Because the other items were left without specific ordering information, the software is able to order the Values 38 and Completed 40 fields to better optimize the form based on the available space. The image of Dynamic Form 42 shows the Completed checkbox 40 on the same line as Title 34 because it fit in the available space.

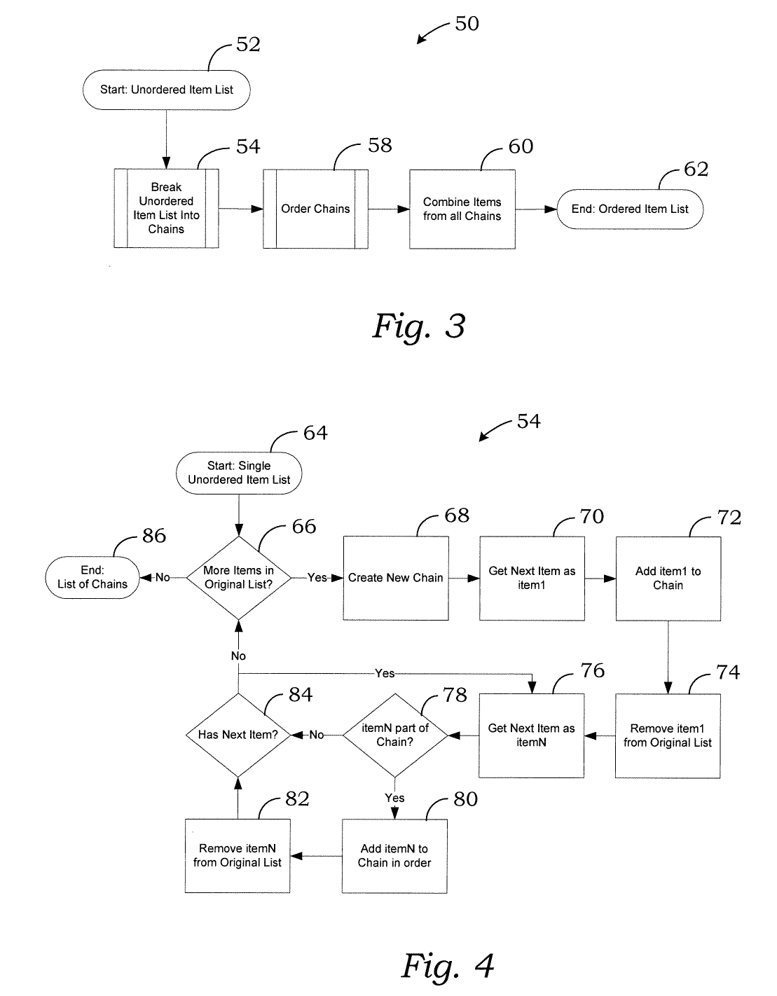

Referring to FIG. 3, a high level flowchart of the algorithm for determining the absolute order at runtime is generally indicated by reference numeral 50. The process starts with an unordered item list 52 with relative ordering information attached to each item.

There are generally three steps to the algorithm:

1. Break unordered item list into chains, block 54

2. Order chains, block 58

3. Combine items from all chains, block 60

The process ends with an absolutely ordered item list block 62. The relative ordering information is still attached to each item so the process may be repeated.

FIG. 4 shows the algorithm 54 for breaking a collection of unordered items with relative ordering information into unbreakable chains. Chains consist of one or more items with “immediately before” or “immediately after” references to other objects. These chains cannot be broken apart any further because the items in them all relate to one another using these “immediate” concepts.

Depending on the relative ordering information, there may be only one chain created from this algorithm or there could be many. The algorithm to break an unordered item list into chain 54 begins with a single unordered item list block 64. If there are more items in the list, block 66, a new chain is created, block 68. The next item in the list is identified, block 70, and added to the chain, block 72. The item is removed from the original list, block 74, and the next item is identified 76. If the item N is related to the item 1 in the chain as being either “immediately before” or “immediately after” block 78, it is added to the chain, block 80, item N is removed from the list, block 82. The next item is then read from the list 84. Only when items are added to a chain are they removed from the original list. If additional items have not been read from the original list, processing returns to block 76. If all items have been read, processing returns to block 66. This process continues until all items are added to a chain and removed from the original list resulting in a list of chains 86.

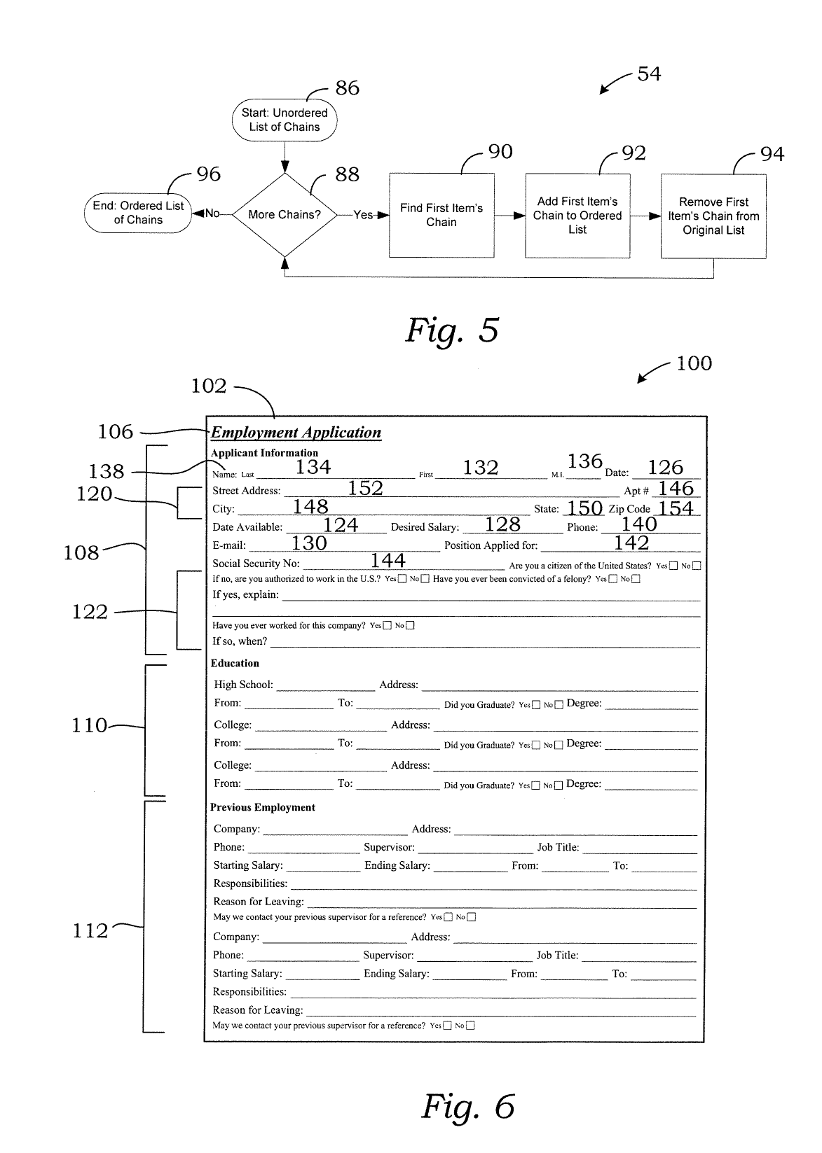

Referring to FIG. 5, the unordered list of chains, block 86, is read, block 88. The first item in the chain is identified, block 90, and added to the list of ordered chains, 92. The item is removed from the original claim 94, and the process is repeated, block 88, until all items are read resulting in an ordered chain a96.

Once the chains are ordered and the items within them ordered, each item is added to a completely new list, one by one, starting with the first item in the first chain, continuing to each item in the first chain, then to the first item in the second chain and so on until the last item from the last chain is added to the full list. This new list is what is returned to the caller of the algorithm so it may be used as if it were a normal absolutely ordered list. All of the original relative ordering information is retained so that the items may be reordered using the same algorithm again.

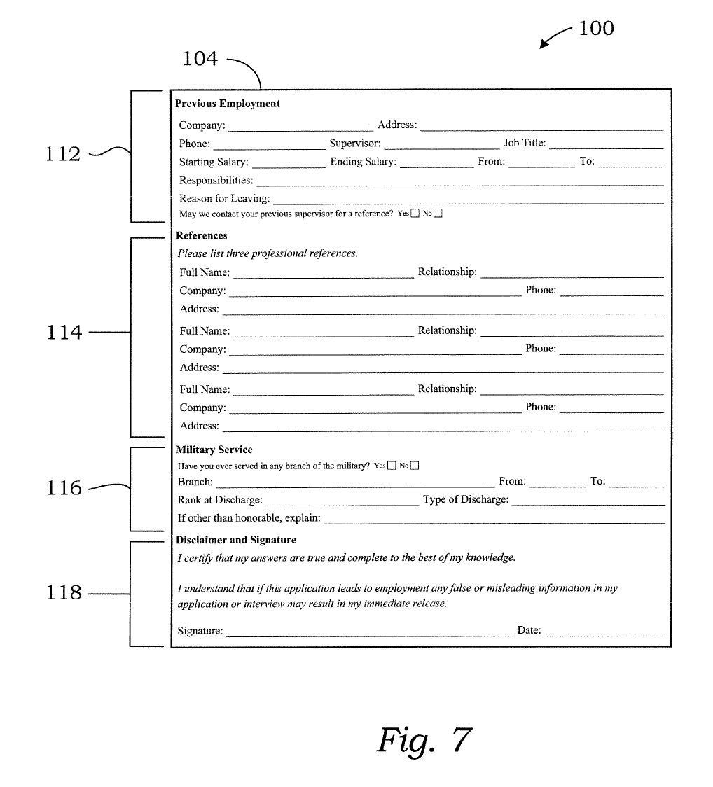

In another example, an employment application form 100 may be arranged according to the present method. Referring to FIGS. 6 and 7, employment application 100 is broken into two Fig. s to show the front 102 and back 104 of the form generated according to the present method.

The employment application 100 includes a number of items which are grouped together. These groups or sections include a Title 106, Applicant Information 108, Education 110, Previous Employment 112, References 114, Military Service 116, and Disclaimer and Signature 118. Within each of these sections are related items.

Some of the sections have a relative order based on the placement of another section. For example, the Education section 110 is defined to be placed immediately after the Applicant Information section 108. And the Application Information section 108 is defined to be placed immediately after the Title section 106. These three sections are related to each other forming a chain. The Title section 106 is defined to be placed first on the form.

The Disclaimer and Signature section 118 is defined to be placed last on the form and the Military Service section 116 is defined to be placed immediately before the Disclaimer and Signature section 118 forming another chain.

The Previous Employment 112 and References 114 sections do not include relative order information and are thus independent chains. However, because the other chains previously defined include a first designation and a last designation, these chains will be placed between the other chain in alphabetical order or in an order that best fits on the page.

Once the relative order of each section is determined, the sections are linked together in a chain.

Next, the items within each section are ordered. For example, in the Applicant Information section 108, the following items are included: Address Block 120, Question 122, Date Available 124, Date 126, Desired Salary 128, E-Mail 130, First 132, Last 134, M.I. 136, Name 138, Phone 140, Position Applied for 142 and Social Security No. 144.

Each of the items is considered to determine its relationship to the other items, if any. The first item, Address Block 120, is defined to be placed after the Date 126. Question 122 is defined to be placed last in the Applicant Information section 108. The Date Available item 124 has no relative order information. Date 126 is defined to be placed after Name 138. Desired Salary 128 has no relative order information. The E-Mail item 130 is included in a chain with Phone 140 and defined to fall immediately after Phone 140 which is placed after the Address Block 120.

The items First 132, Last 134, M.I. 136 and Name 138 are included in a chain. First 132 is defined as immediately after Last 134. M.I. 136 is defined as immediately after First 132. Name 138 is defined first resulting in an ordered chain of Name 138, Last 134, First 132 and M.I. 136.

Next, Position Applied for 142 is considered followed by Social Security No. 144, neither of which include relative order information and are thus included in separate chains for ordering purposes and may be placed in alphabetical order.

Since all of the items have been processed into chains, the chains can now be ordered for the Applicant Information section 108 as follows: the Name chain including the items Name 138, Last 134, First 132 and M.I. 136 is defined as first in the section, followed by Date 126, Address Block 120, Date Available 124, Desired Salary 128, the Phone 140 and E-Mail 130 chain, Position Applied for 142, Social Security No. 144, and finally the Question 122 defined as last in the section and thus the last item in the chain.

Next, the items within the Address Block 120 are ordered and organized into chains. Apt. #146 is first considered followed by City 148. City 148 is immediately after Apt. #146 and thus placed at the end of the chain. State 150 is immediately after City 148 so it is placed at the end of the chain. Apt. #146 is defined as immediately after Street Address 152, which is defined as first in the chain, thus Street Address 152 is added to the chain before Apt. #146. Zip Code 154 is defined as last in the chain. Thus, the Address Block 120 is ordered as shown in FIG. 6.

Next the Questions 122 are ordered in a similar manner as described above for the Address Block 120 to achieve the layout shown in FIG. 6.

Each section is ordered in turn until all items in all sections are part of a chain and the relative order of each is determined. At this point the Employment Application for 100 may be dynamically created and saved in the form shown in FIGS. 6 and 7. The items for the form along with the relative position information are preserved so that the form may be repeatedly recreated.

The complete ordering information for the Employment Application form 100 is included in the following table:

| Document Elements | Ordering Information |
|---|---|
| Acme Employment Application | First |
| Title | Immediately After Title |
| Application Information | First |
| Name | Immediately After Name |
| Last | Immediately After Last |
| First | Immediately After First |
| M.I. | After Name |
| Date | After Date |
| Address Block | First |
| Street Address | Immediately After Street Address |
| Apt # | Immediately After Apt # |
| City: | Immediately After City |
| State: | Last |
| Zip Code | After Address Block |
| Date Available | Immediately After Phone |
| Desired Salary | Last |
| Phone | First |
| E-mail | Immediately After Are you a citizen of the United |
| Position Applied for | States? |
| Social Security No: | Last |
| Questions | First |
| Citizen? | Last |
| Are you a citizen of the United States? | First |
| Yes | Immediately After Felony? |
| No | Last |
| Authorized to work in US? | First |
| If no... | Immediately After Worked for company? |
| Yes | Last |
| No | Immediately After Application Information |
| Felony? | First |
| Felony? | First |
| Yes | Immediately After High School |
| No | Immediately After From |
| If yes, explain | Immediately Before Degree |
| Worked for this company? | First |
| Worked for company? | Last |
| Yes | Last |
| No | First |
| If so, when? | Immediately After College |
| Education | Immediately After From |
| High School | Immediately Before Degree |
| High School | First |
| Address | Last |
| From | Last |
| To | First |
| Graduate? | Immediately After College |
| Graduate? | Immediately After From |
| Yes | Immediately Before Degree |
| No | First |
| Degree | Last |
| College | Last |
| College | First |
| Address | After Company |
| From | Immediately After Address |
| To | After Company |
| Graduate? | After Supervisor |
| Graduate? | After Job Title |
| Yes | After Starting Salary |
| No | Immediately Before To |
| Degree | Immediately Before Contact |
| College 2 | Immediately Before Yes |
| College | Immediately Before No |
| Address | Last |
| From | First |
| To | After Company |
| Graduate? | Immediately After Address |
| Graduate? | After Company |
| Yes | After Supervisor |
| No | After Job Title |
| Degree | After Starting Salary |
| Previous Employment | Immediately Before To |
| Group 1 | Immediately Before Contact |
| Company | Immediately Before Yes |
| Address | Immediately Before No |
| Phone | Last |
| Supervisor | First |
| Job Title | After Company |
| Starting Salary | Immediately After Address |
| Ending Salary | After Company |
| From | After Supervisor |
| To | After Job Title |
| Responsibilities | After Starting Salary |
| Reason for Leaving | Immediately Before To |
| Contact | Immediately Before Contact |
| Yes | Immediately Before Yes |
| No | Immediately Before No |
| Group 2 | Last |
| Company | First |
| Address | First |
| Phone | After Full Name |
| Supervisor | After Relationship |
| Job Title | After Company |
| Starting Salary | Last |
| Ending Salary | First |
| From | After Full Name |
| To | After Relationship |
| Responsibilities | After Company |
| Reason for Leaving | Last |
| Contact | First |
| Yes | After Full Name |
| No | After Relationship |
| Group 3 | After Company |
| Company | Last |
| Address | Immediately Before Disclaimer and Signature |
| Phone | First, Immediately After No |
| Supervisor | First |
| Job Title | Immediately After Have you? |
| Starting Salary | Immediately After Yes |
| Ending Salary | Immediately After Branch |
| From | Immediately After From |
| To | Immediately Before Type of Discharge |
| Responsibilities | Immediately Before If other than honorable, explain |
| Reason for Leaving | Last |
| Contact | Last |
| Yes | First |
| No | Last |
| References | |
| Instructions | |
| Group 1 | |
| Full Name | |
| Relationship | |
| Company | |
| Phone | |
| Address | |
| Group 2 | |
| Full Name | |
| Relationship | |
| Company | |
| Phone | |
| Address | |
| Group 3 | |
| Full Name | |
| Relationship | |
| Company | |
| Phone | |
| Address | |
| Military Service | |
| Branch | |
| Have you? | |
| Yes | |
| No | |
| From | |
| To | |
| Rank at Discharge | |
| Type of Discharge | |
| If other than honorable, explain | |
| Disclaimer and Signature | |
| Disclaimer | |
| Signature | |
| Date | |

Non-visual items may also be ordered using the aforementioned algorithm. For example, priorities could have a relative ordering component to them. Instead of high, medium and low priorities, for example, items could be “prioritized” using before, after, immediately before, immediately after, first and last. These might equate to the following phrases: higher, lower, immediately higher, immediately lower, highest and lowest. By mapping the names to the previously defined concepts, the same algorithm may be used for many different applications.

Furthermore, nesting may be used to create hierarchical ordering. One example is a group of items, whereas one or more items within a group could be groups themselves. Because the groups within a higher-level group can contain relative ordering information, these groups of items may be ordered independent of the items within them. All items at a higher level in the hierarchy may be ordered first, using the algorithm above then the items of each group at that level may be ordered, one group at a time, and so on for every group within a group. This hierarchical grouping of items and ordering of these items one by one creates an even more powerful system of ordering.

A combination of the hierarchical ordering and the remapping of phrases to the predefined ordering concepts give us the ability to visually lay out items on a page based on relative ordering information. One way to do this is to consider a line to be a horizontal arrangement of items, whereas a page is a vertical arrangement of lines. As in the groups above, pages contain lines and lines contain items. One can remap the following phrases for the lines in a page: above, below, immediately above, immediate below, top and bottom. One can also remap the following phrases for items in a line: to the left of, to the right of, immediately to the left of, immediately to the right of, leftmost and rightmost.

Even an absolutely ordered list may be mapped into this relative ordering paradigm simply by assigning immediately before or immediately after relative ordering information to each item in the collection based on the order it appears in the collection. For example, the first item could be left without additional information, but the next item would have relative ordering information that indicates it is immediately after the first item. The third item would be annotated as immediately after the second item, and so on down the line. This additional annotation may be done very quickly and allows the relative ordering algorithm to work on the absolutely ordered list.

The capabilities of the relative ordering algorithm may be extended to any ordered collection or hierarchy of items, simply by using the relative ordering information and repeating the algorithm for each collection at each level in the hierarchy.

The current implementation of the relative ordering scheme orders items alphabetically if there is no other information requiring that they be non-alphabetical. Also, the behavior is undefined if there are conflicts in the ordering information, though it will generally go with the most specific rule (e.g., first or last supersedes immediately before and immediately after, which supersedes before and after).

Even with this powerful tool, the user can give too much ordering information, thereby reducing the effectiveness of the relative ordering scheme. For example, if the user were to indicate that the Completed checkbox in FIG. 2 should be last, there would be no way to move the Completed checkbox onto the same line as the title field. For this reason, the mechanism may be extended to include the concept of priority. Again, the purpose is to get intent from the user rather than specific instructions. Using a priority allows conflicts to be resolved more effectively, and if space is limited, ordering information with a lower priority may be safely ignored.

It is to be understood that while certain forms of this invention have been illustrated and described, it is not limited thereto, except in so far as such limitations are included in the following claims and allowable equivalents thereof.

Having thus described the invention, what is claimed as new and desired to be secured by Letters Patent is:

1. A method for creating an ordered item list from an unordered item list based on associated relative ordering information comprising:
receiving an unordered item list selected by a user wherein said unordered item list includes at least three items and at least one of the items includes item relative ordering information,
separating said unordered item list into chains of related items, wherein at least one of said chains of items includes chain's relative ordering information,
ordering said related items within each chain according to said item relative ordering information,
combining said chains to form an ordered item list according to said chain relative ordering information presenting an absolutely ordered list.

2. The method as set forth in claim 1 wherein said item relative ordering information includes information to place each item in a list relative to other items in the list.

3. The method as set forth in claim 2 wherein said item relative ordering information includes placing the items in alphabetical order in the list.

4. The method as set forth in claim 2 wherein said item relative ordering information includes a First designation wherein an item having said First designation is placed first in said list relative to other related items in said list, a Last designation wherein an item having said Last designation is placed last in said list relative to other related items in said list, a Before designation wherein an item having said Before designation is placed before another related item in said list, an After designation wherein an item having said After designation is placed after another related item in said list, an Immediately Before designation wherein an item having said Immediately Before designation is placed immediately before another related item in said list, and/or an Immediately After designation wherein an item having said Immediately After designation is placed immediately after another related item in said list.

5. The method as set forth in claim 1 wherein said chain relative ordering information includes information to place each chain of items in a list relative to other chains of items in the list.

6. The method as set forth in claim 5 wherein said chain relative ordering information includes a First designation wherein a chain having said First designation is placed first in said list relative to other related chains in said list, a Last designation wherein a chain having said Last designation is placed last in said list relative to other related chains in said list, a Before designation wherein a chain having said Before designation is placed before another related chain in said list, an After designation wherein a chain having said After designation is placed after another related chain in said list, an Immediately Before designation wherein a chain having said Immediately Before designation is placed immediately before another related chain in said list, and/or an Immediately After designation wherein a chain having said Immediately After designation is placed immediately after another related chain in said list.

7. A method for creating an ordered item list from an unordered item list based on associated relative ordering information comprising:
while more items are in an unordered list of items, iteratively performing the following steps a-g:
a. selecting the first item from the unordered list of items having at least one item,
b. creating a new chain,
c. adding the item to the chain,
d. deleting the item from the unordered list of items,
e. iteratively repeating the following steps f and g until all items from the unordered list of items have been selected,
f. selecting the next item from the unordered list of items,
g. if the next item is related to the item, then adding the next item to the chain, and deleting the next item from the unordered list of items,
for each chain created in step b, ordering the items within the chain according to item relative ordering information associated with the items,
ordering said chains according to chain relative ordering information associated with the chain, and
presenting an absolutely ordered list.

8. The method as set forth in claim 7 wherein said item relative ordering information includes information to place each item in a list relative to other items in the list.

9. The method as set forth in claim 8 wherein said item relative ordering information includes placing the items in alphabetical order in the list.

10. The method as set forth in claim 8 wherein said item relative ordering information includes a First designation wherein an item having said First designation is placed first in said list relative to other related items in said list, a Last designation wherein an item having said Last designation is placed last in said list relative to other related items in said list, a Before designation wherein an item having said Before designation is placed before another related item in said list, an After designation wherein an item having said After designation is placed after another related item in said list, an Immediately Before designation wherein an item having said Immediately Before designation is placed immediately before another related item in said list, and/or an Immediately After designation wherein an item having said Immediately After designation is placed immediately after another related item in said list.

11. The method as set forth in claim 7 wherein said chain relative ordering information includes information to place each chain of items in a list relative to other chains of items in the list.

12. The method as set forth in claim 11 wherein said chain relative ordering information includes a First designation wherein a chain having said First designation is placed first in said list relative to other related chains in said list, a Last designation wherein a chain having said Last designation is placed last in said list relative to other related chains in said list, a Before designation wherein a chain having said Before designation is placed before another related chain in said list, an After designation wherein a chain having said After designation is placed after another related chain in said list, an Immediately Before designation wherein a chain having said Immediately Before designation is placed immediately before another related chain in said list, and/or an Immediately After designation wherein a chain having said Immediately After designation is placed immediately after another related chain in said list.

13. A method for creating an ordered item list from an unordered item list based on associated relative ordering information comprising:
while more items are in an unordered list of items, iteratively performing the following steps a-g:
a. selecting the first item from the unordered list of items having at least one item,
b. creating a new chain,
c. adding the item to the chain,
d. deleting the item from the unordered list of items,
e. iteratively repeating the following steps f and g until all items from the unordered list of items have been selected,
f. selecting the next item from the unordered list of items,
g. if the next item is related to the item, then adding the next item to the chain, and deleting the next item from the unordered list of items,
for each chain created in step b, ordering the items within the chain according to item relative ordering information associated with the items to place each item within the chain relative to other items in the chain,
ordering said chains according to chain relative ordering information associated with the chain, and
presenting an absolutely ordered list.

14. The method as set forth in claim 13 wherein said item relative ordering information includes a First designation wherein an item having said First designation is placed first in said list relative to other related items in said list, a Last designation wherein an item having said Last designation is placed last in said list relative to other related items in said list, a Before designation wherein an item having said Before designation is placed before another related item in said list, an After designation wherein an item having said After designation is placed after another related item in said list, an Immediately Before designation wherein an item having said Immediately Before designation is placed immediately before another related item in said list, and/or an Immediately After designation wherein an item having said Immediately After designation is placed immediately after another related item in said list.

15. The method as set forth in claim 13 wherein said chain relative ordering information includes a First designation wherein a chain having said First designation is placed first in said list relative to other related chains in said list, a Last designation wherein a chain having said Last designation is placed last in said list relative to other related chains in said list, a Before designation wherein a chain having said Before designation is placed before another related chain in said list, an After designation wherein a chain having said After designation is placed after another related chain in said list, an Immediately Before designation wherein a chain having said Immediately Before designation is placed immediately before another related chain in said list, and/or an Immediately After designation wherein a chain having said Immediately After designation is placed immediately after another related chain in said list.
